(19) United States
(12) Patent Application Publication
(10) Pub. No.: US 2001/0014272 A1
(43) Pub. Date: Aug. 16, 2001

(54) HITCH LIFT

(76) Inventors: SANDY OCHOA, ALANOGORDO, NM (US); MARK A. BURCH, ALAMOGORDO, NM (US)

Correspondence Address: Sandy Ochoa, 505 24th Street, Buidling#4, Alanogordo, NM, 88310, US

(21) Appl. No.: 09/430,680

(22) Filed: Oct. 29, 1999

(51) Int. Cl. B60P 9/00

(52) U.S. Cl. 414/462; 414/546; 414/557; 414/917

(57) ABSTRACT

A lift for lifting heavy items onto the bed of a motor vehicle, whereby the lift is portable and removably attached to the motor vehicle via a receiver hitch. The entire lift hitch is slid into place on the receiver hitch for common towing ball structures that are on some motor vehicles or are readily available on all motor vehicle. The lift hitch does not require removal of the vehicle tailgate or permanent attachments to the vehicle frame or bumper. The lift hitch forks or platform can be lowered to ground level and raised to the tailgate level. The lifting and lowering mechanism can be an electric motor, hydraulic system, or hand turned ratchet mechanism.

### BACKGROUND OF THE INVENTION

1. Field of the Invention (Technical Field)

The invention relates to truck lifts, but more particularly to lifts that are portable and attach to a receiver hitch for loading and unloading heavy items to and from a vehicle.

2. Background Art

With the advent of stationary lift gates, there is a need for a portable lift that can attach to the vehicle's receiver hitch for stability and load bearing strength, allowing this lift to be used on most vehicles that have a receiver hitch, making the lift portable.

There are several lifts available that require extensive installation by trained personnel, making the lifts more permanent, usually with the capability of lifting over 1000 pounds, and are quite heavy. They require that the tailgates be removed and most require a permanent installation or attachment fittings welded or bolted to the vehicle frame or bumper. These devices primarily use hydraulic pumps and jacks as the lifting mechanism. None of the above employ the use of the receiver hitch for one step installation.

### SUMMARY OF THE INVENTION (DISCLOSURE OF THE INVENTION)

In accordance with the present invention, there is an apparatus and method for mounting a lift that will be portable, attached to a receiver hitch and with a winch for lifting and lowering a platform or a set of forks, preferably powered by DC electricity available on the vehicle. The load can be dollied onto a platform or forks on the hitch lift and then dollied onto the bed of the vehicle. Alternative embodiments of the present invention for lifting and lowering the platform or forks of the hitch lift, can include hydraulics, pneumatics, electric gear drives or hand cranked winches. Multiple positions are provided to accommodate most variances in the size and height of tailgates and vehicles.

The preferred lifting and lowering apparatus comprises an apparatus to keep the forks or platform of the hitch lift substantially parallel to the ground throughout the lifting and lowering operation. The preferred apparatus comprises a floating parallelogram comprising two sets of fulcrum point plates in conjunction with two sets of parallel leverage arms of equal length. The preferred apparatus comprises a plate assembly comprising a stationary yoke, an adjustable weight support, and two primary fulcrum point plates affixed to the stationary yoke.

A primary object of the invention is the provision of a lift that can be installed onto a vehicle utilizing a standard hitch receiver.

Another object of the invention is to provide a lift to a vehicle without having to permanently attach the lift to the vehicle.

Another object of the invention is to provide a lift that can easily be installed on a vehicle.

A primary advantage of the present invention is that it is portable.

Another advantage of the present invention is that it uses a standard hitch receiver for installation on the vehicle.

Yet another advantage of the present invention is that it can be used on any type vehicle without modification.

Another advantage of the present invention is the ease of manufacture and its low cost.

Other objects, advantages, novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1A depicts the hitch lift in the up position;

FIG. 1 B depicts the hitch lift in the down position;

FIG. 2A shows the hitch lift attached to a vehicle in the up position;

FIG. 2B shows the hitch lift attached to a vehicle in the down position;

FIG. 3 is a perspective view of the preferred embodiment of the invention;

FIG. 4 is a detailed view of one side of the hitch lift; and

FIG. 5 is a perspective view of an alternative embodiment of the hitch lift.

### DESCRIPTION OF THE PREFERRED EMBODIMENTS (BEST MODES FOR CARRYING OUT THE INVENTION)

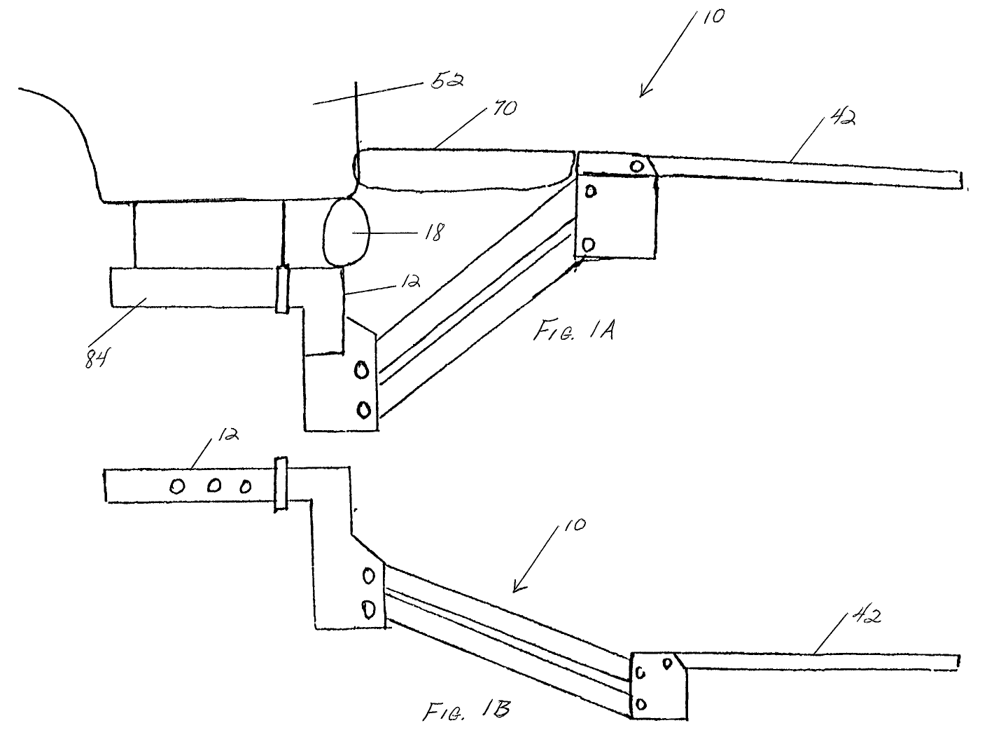

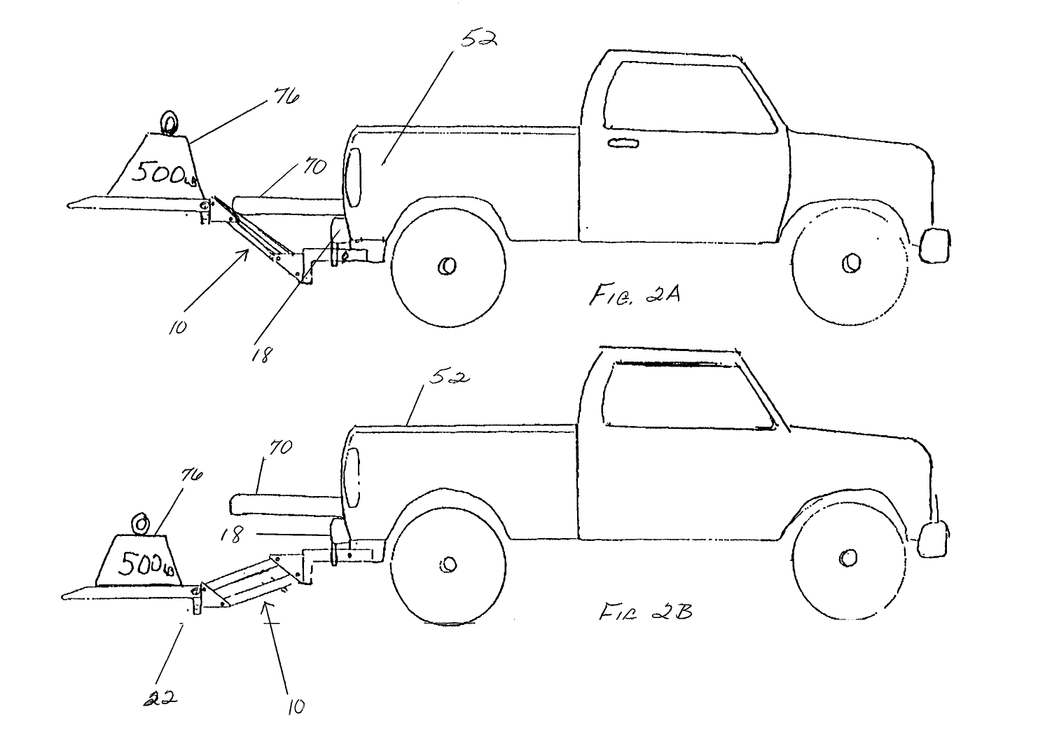

Lifts for trucks are used to lift heavy objects from the ground to the level of the vehicle bed for transport. Several types of lifts have been commercialized. The present invention is an improvement to the presently available lifts due to the use of a hitch receiver to attach the lift apparatus to the vehicle. The preferred embodiment of the invention is shown in FIGS. 1A, 1B, 2A, 2B, 3, and 4. A male portion of a receiver hitch 12 attached in a perpendicular fashion to a fulcrum plate assembly 14. Plate assembly 14 preferably consists of a rectangular, stationary yoke 16 that runs parallel to bumper 18 of vehicle 52, an adjustable weight support 20 that extends to ground 22, and two primary fulcrum point plates 24 that attach to the aforementioned stationary yoke 16 in a perpendicular fashion on each end of stationary yoke 16 as shown. Attached to and extending from a pair of offset apertures 28 on each of the primary fulcrum point plates 24, are four leverage arms 30 (two to each fulcrum point plate) of equal length. Each leverage arm 30 has a leverage arm aperture 32 on a first end 82, that extends parallel to primary fulcrum point plates 24. The four leverage arms 30 connect to a pair of secondary fulcrum point plates 34 by four equally offset apertures 36 that match the offset apertures 28 in primary fulcrum point plates 24. These secondary fulcrum point plates 34 are attached perpendicularly to a floating yoke 38, thereby forming a “box” between the stationary yoke 16 and the floating yoke 38, and the two pairs of leverage arms 30 that “swivel” vertically up and down. Also extending between the secondary fulcrum point plates 34 and in close proximity, slightly above and behind the floating yoke 38, is a round bar 40 that attaches to a pair of load bearing forks 42 in a perpendicular fashion by means of two hollow cylindrical sleeves 44 (only one is shown) that slip over the round bar 40. These load bearing forks 42 rest on the floating yoke 38 at the floating yoke ends 46 where the sleeves 48 are located with the open ends of the forks 50 extending away from the vehicle 52. The load bearing forks 42 are lifted up and down by a winch 54 that is bolted to a winch mounting plate 56 that is attached to the top of the stationary yoke 16 with the winch spool 58 being parallel to the bumper 18 of the vehicle 52. The cable extended end of the winch 60 is attached to floating yoke 38 that is attached to the lower pair of leverage arms 30 as shown. An alternative version of the invention uses a pulley that is attached to the floating yoke 38, while the winch cable 66 is “threaded” through this pulley 64 and run back up to the stationary yoke 16 where it is fixed to it just underneath the winch mounting plate 56 to eyelet 68. This configuration allows the said invention to work with less load for a set amount of weight lifted. Although, the preferred embodiment above discusses the use of a winch, other well known devices can be used, such as hydraulics, hand crank ratchet devices and the like (not shown).

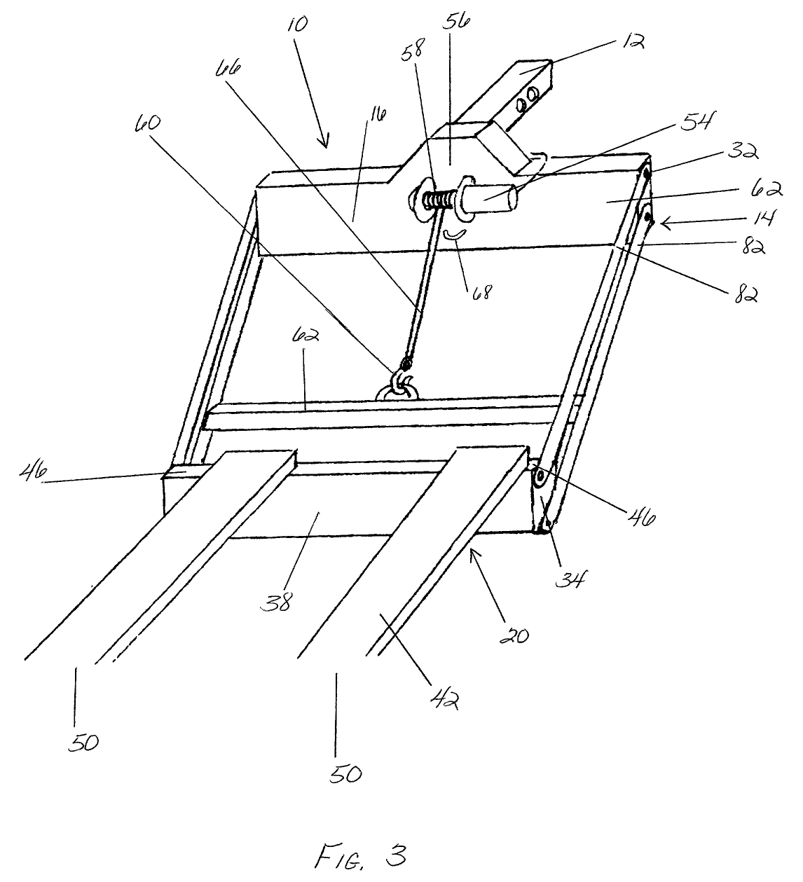

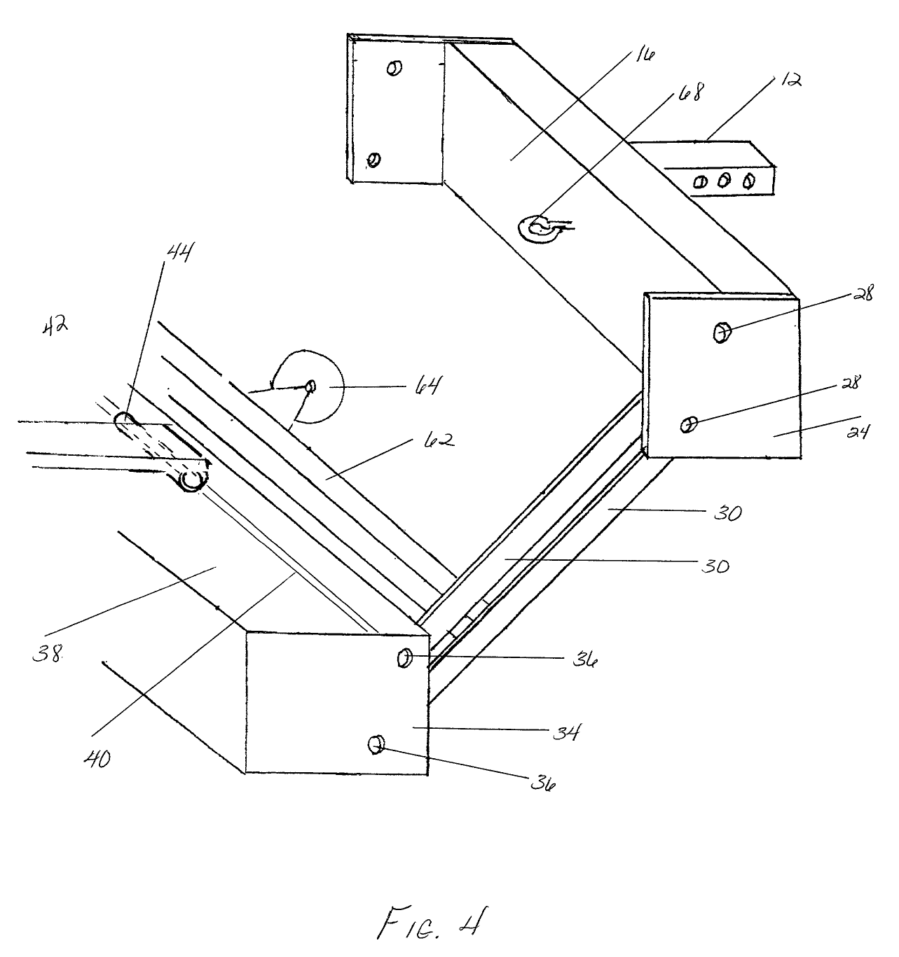

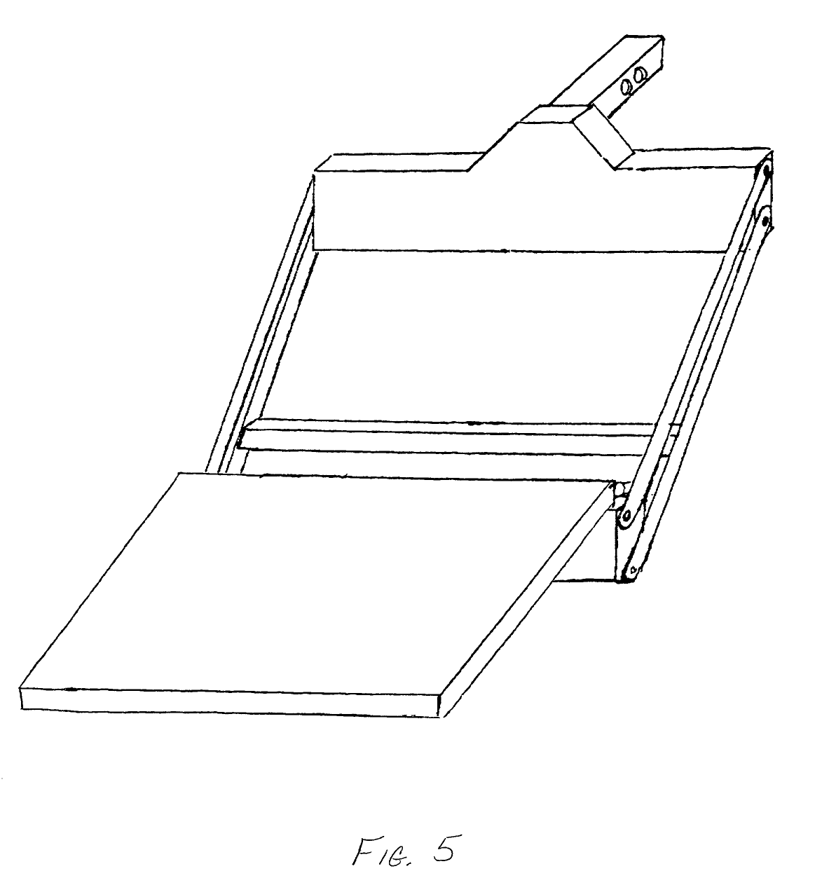

FIGS. 1A, 1B, 2A, 2B, 3 and 4 show how the invention works. Winch 54 pulls in or releases the cable 66 that is attached lifting yoke 62 as shown in FIG. 3. In the alternative winch 54 pulls or releases cable 66 threaded through pulley 64 and then secured to the stationary yoke 16 by means of an eye hook 68, as shown in FIG. 4. This motion allows the invention to raise or lower heavy objects from bed 78 of the respective vehicle 52. The primary mechanical principle involved is leverage. As with all levers one needs a stationary point, and in this case it is provided ultimately by the vehicle 52 itself. All functions of this lifting unit are relative to the vehicles respective position which should be substantially horizontal or parallel to the ground 22 and not on an incline. The first order of operation is to connect the lift hitch 10 to the rear of the vehicle 52 simply by sliding the male side of the receiver hitch 12 into the matching aperture and pinning it into place. The platform or forks 72 are then lowered to the ground 22 in its working position, thereby taking a significant amount of weight off of the hitch itself when the lift hitch 10 is under a load and placing it at a low center of gravity. The tailgate 70 is then dropped to its down position and the lift hitch 10 is moved to the “down position” with forks 72 touching the ground 22, thus removing tension on cable 66. A pallet can be placed over the forks 72 to create a lifting platform (not shown). As show in FIG. 5, instead of forks, a flat platform, a specially designed holding apparatus or other similar structure, well known in the art can be used. Load 76 is placed onto the platform and winch 54 is engaged, drawing the cable 66 in, and causing forks 42 to rise. Cable 66, by being drawn into winch 54 (the working part of this lever) at an angle greater than the four (two sets parallel) leverage arms 30 creates a centrifugal motion in the leverage arms 30 that raises the load 76 linearly as well as circularly up and towards the vehicle's open tailgate 70. Load 76 is able to maintain a horizontal and parallel position in relation to the vehicle bed 78 by the use of a floating parallelogram that is created by the two sets of fulcrum point plates 24 in conjunction with the four equally long leverage arms 30. The entire fulcrum assembly holds the parallel sets of leverage arms 30 stationary at the top of the primary fulcrum point plates 24, with the equally offset holes 28 in the primary fulcrum point plates 24 and secondary fulcrum point plates 34 positioned to keep the forks 42 parallel to the bed of the vehicle 78. As the leverage arms 30 are drawn centrifugally upwards by the winch cable 66, the parallel angle of the forks 42 is maintained by the equally offset holes 28 and 36 of the fulcrum point plates 24 and 34. The winch 54, which drives the parallel leverage arms 30 up and down, again creates a simple machine principle when working in conjunction with the pulley 64. As the winch 54 draws cable 66 in, it shortens the distance from winch 54 to pulley 64, and thereby creates the motion of a “moving pulley” between the pulley 64 mounted on the lifting yoke 62 and the primary fulcrum point 80. This allows an increasingly strong upward pulling motion as the variant angle increases between the leverage arms 30 and the winch cable 66. These principles of operation work not only to lift from the ground level 22 to the tailgate 70 of the vehicle 52 but also to lower heavy objects from the tailgate 70 back to the ground level 22.

The lift hitch 10 is designed to compactly collapse once the unit is not in use. Once the lift hitch is collapsed, the tailgate 70 can be raised and the vehicle is ready to be driven to its destination. The fulcrum point plate holes 28 are offset at an angle sloping away from the vehicle 52 towards the ground 22 so that the overall travel of the cable draw could allow the unit to be raised to a height that exceeds the tailgate plane, and thereby draws the lift hitch 10 close to the closed tailgate 70 of the vehicle 52. The forks 42 pivot on the round bar 40 so they can be turned backwards prior to the unit being drawn up to its stored mobile height, giving it a very low profile that does not exceed legally acceptable limits.

The lift hitch 10 can be easily removed from the vehicle 52 by simply extending the winch 54 to put the forks 42 in the down position on the ground 22, and then pulling the pin in the receiver hitch mechanism and pulling the unit free of the receiver 84.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. An apparatus for lifting and lowering objects to and from a motor vehicle comprising:
a hitch receiver for inserting into a female receiver aperture attached to a motor vehicle; and
a lifting and lowering apparatus comprising:
a plate assembly comprising a stationary yoke;
an adjustable weight support; and
two primary point fulcrum plates affixed to said stationary yoke.
